(19) United States
(12) Patent Application Publication
(10) Pub. No.: US 2026/0138201 A1
(43) Pub. Date: May 21, 2026

(54) ADAPTIVE WELDING

(71) Applicant: LIBURDI ENGINEERING LIMITED, Dundas, Ontario (CA)

(72) Inventors: Janusz BIALACH, Dundas (CA); Michael Edwin WRIGHT, Dundas (CA); Robert Joseph PISTOR, Dundas (CA)

(21) Appl. No.: 19/123,370

(22) PCT Filed: Oct. 23, 2023
(86) PCT No.: PCT/IB2023/000682

§ 371 Date: Apr. 22, 2025

Related U.S. Application Data
(60) Provisional application No. 63/380,686, filed on Oct. 24, 2022.

(51) Int. Cl. B23K 9/095; B23K 9/12

(52) U.S. Cl. CPC B23K 9/0956; B23K 9/12

(57) ABSTRACT

A system and method for adaptive welding. In some embodiments, the system includes a weld head, a first weld monitoring camera, and a machine learning system. The machine learning system may be configured, while the weld head forms a weld layer in a groove, to estimate the position of a distal end of a filler wire relative to the groove.

### CROSS-REFERENCE TO RELATED APPLICATION(S)

The present application claims priority to and the benefit of U.S. Provisional Application No. 63/380,686, filed Oct. 24, 2022, entitled “ADAPTIVE WELDING”, the entire content of which is incorporated herein by reference.

### FIELD

One or more aspects of embodiments according to the present disclosure relate to welding, and more particularly to systems and methods for control of welding systems.

### BACKGROUND

Welding systems may be employed to produce welds in an automated or partially automated fashion. In the process of producing such a weld, various parameters may be adjusted, including, for example the position of a heat source or filler wire relative to a weld groove, the travel rate, or the filler wire feed speed.

It is with respect to this general technical environment that aspects of the present disclosure are related.

### SUMMARY

According to an embodiment of the present disclosure, there is provided a system for welding, including: a weld head; a first weld monitoring camera; and a machine learning system, wherein the machine learning system is configured, while the weld head forms a weld layer in a groove, to estimate the position of a distal end of a filler wire relative to the groove.

In some embodiments, the estimating includes estimating, based on an image obtained by the first weld monitoring camera, the position of a first point of interest, the first point of interest being a point of intersection of a first edge of the groove with a reference plane.

In some embodiments, the estimating includes estimating the position of four points of interest including the first point of interest, each of the four points of interest being a point of intersection of an edge of the groove with the reference plane.

In some embodiments, the estimating of the position of the first point of interest includes estimating, in the image, an intersection of a line corresponding to the first edge and a line corresponding to the reference plane.

In some embodiments, the machine learning system is further configured to estimate the depth of the groove.

In some embodiments, the machine learning system is further configured to estimate the width of the bottom of the groove.

In some embodiments, the estimating further includes estimating the position of a fifth point of interest, the fifth point of interest corresponding to the distal end of a filler wire.

In some embodiments, the machine learning system is further configured to estimate an error in the position of the distal end of the filler wire relative to a target position of the distal end of the filler wire.

In some embodiments, the estimating further includes estimating the position of a sixth point of interest, the sixth point of interest corresponding to the tip of a tungsten electrode of the weld head.

In some embodiments, the machine learning system is further configured to estimate an error in the position of the tip of the tungsten electrode relative to a target position of the tip of the tungsten electrode.

In some embodiments, the machine learning system includes a first neural network for estimating, in an image obtained by the first weld monitoring camera, a position of a tungsten electrode.

In some embodiments, the machine learning system further includes a second neural network for estimating a position of the distal end of a filler wire.

In some embodiments, the estimating of the position of the distal end of the filler wire includes estimating the position of the distal end of the filler wire based on: an estimated position of the tungsten electrode; and the image.

In some embodiments, the machine learning system further includes a third neural network for estimating a position of an upper edge of the groove.

In some embodiments, the machine learning system includes a fourth neural network for estimating a position of a lower edge of the groove.

In some embodiments, the estimating of the position of the lower edge of the groove includes estimating the position of the lower edge of the groove based on: an estimated position of the upper edge of the groove; and the image.

According to an embodiment of the present disclosure, there is provided a method, including: calculating a travel speed of a substrate relative to a weld head, based on: a feed speed of a filler wire; a dimension of the filler wire; and a dimension of a weld layer to be formed.

In some embodiments, the dimension of the filler wire is the diameter of the filler wire.

In some embodiments: the dimension of the weld layer is the thickness of the weld layer, and the calculating is further based on the width of the weld layer.

In some embodiments, the calculating is further based on an efficiency factor.

### BRIEF DESCRIPTION OF THE DRAWINGS

These and other features and advantages of the present disclosure will be appreciated and understood with reference to the specification, claims, and appended drawings wherein:

FIG. 1A is a cross-sectional view of a substrate, according to an embodiment of the present disclosure;

FIG. 1B is a cross-sectional view of a substrate and a weld layer, according to an embodiment of the present disclosure;

FIG. 1C is a side view of a gas tungsten arc welding system, according to an embodiment of the present disclosure;

FIG. 1D is a side view of a gas metal arc welding system, according to an embodiment of the present disclosure;

FIG. 2A is schematic drawing of an image captured by a weld monitoring camera, according to an embodiment of the present disclosure;

FIG. 2B is schematic drawing of an image captured by a weld monitoring camera, according to an embodiment of the present disclosure;

FIG. 2C is an image captured by a weld monitoring camera, according to an embodiment of the present disclosure;

FIG. 3A is a block diagram of a neural network, according to an embodiment of the present disclosure;

FIG. 3B is a block diagram of a neural network, according to an embodiment of the present disclosure; and

FIG. 4 is a block diagram of a welding system, according to an embodiment of the present disclosure.

### DETAILED DESCRIPTION

The detailed description set forth below in connection with the appended drawings is intended as a description of exemplary embodiments of systems and methods for control of welding systems provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a welding system two pieces of metal (e.g., metal plates or pipes) may be joined by filling a groove (which may have a triangular, rectangular, or trapezoidal cross section), at the line of contact between the pieces of metal, with molten metal, in one or more passes. The pieces of metal (together with any partially completed weld) may together be referred to as the substrate. The filler metal may be supplied by a filler wire, and heat may be supplied by an arc. In a gas tungsten arc welding (GTAW) (or tungsten inert gas (TIG)) process, the arc may be formed between a tungsten electrode and the weld pool; in a gas metal arc welding (GMAW) (or metal inert gas (MIG)) process, the arc may be formed between the filler wire and the weld pool. In other processes, the heat may be supplied by another heat source, e.g., a laser.

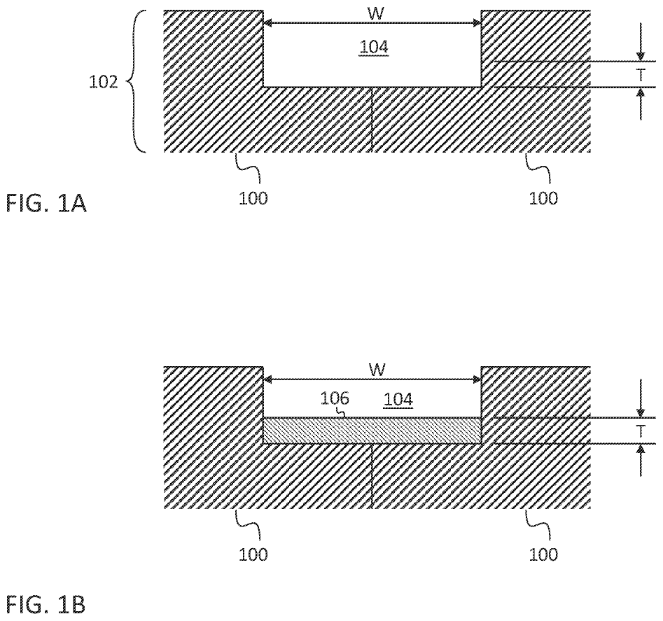

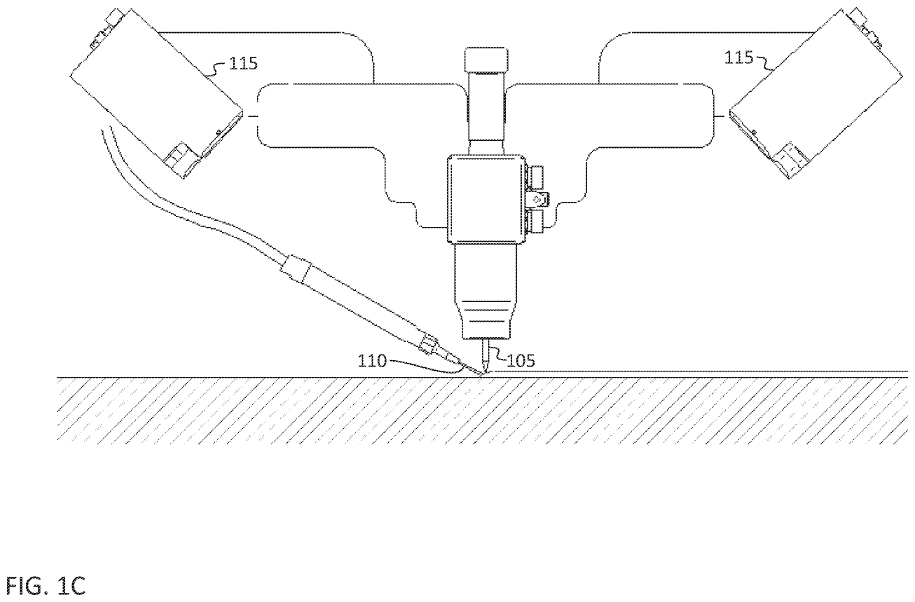

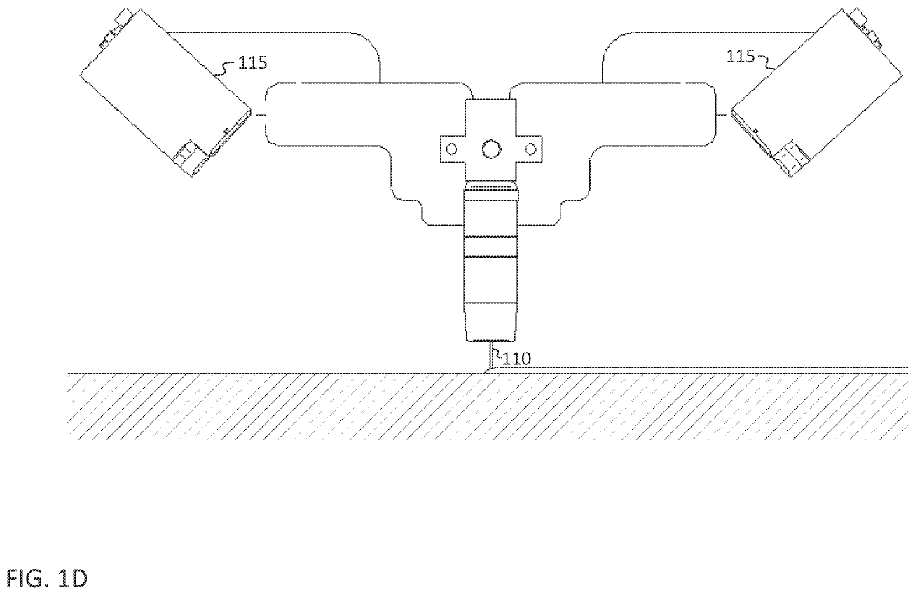

For example, referring to FIG. 1A, when performing machine (i.e., automated) pipe welding, two pipes 100 may be positioned end to end, and the ends of the two pipes may be shaped such that a groove 104 is formed around the outer circumferences of the ends of the pipes. The groove 104 may then be partially or entirely filled, as shown in FIG. 1B, using one or more weld passes, each pass forming an additional weld layer 106 in the groove 104. The pipes 100 may collectively be referred to as the substrate 102.

Referring to FIGS. 1C and 1D, the welding system may include a weld head that includes the heat source and a filler wire feed system. A welding control system may include motors or other actuators for controlling the relative positions of the elements of the weld head and the substrate, as well as the wire feed, as the weld progresses. For example, the welding control system may include a travel control system that controls the travel speed (e.g., that controls the movement of the weld head along the length of the groove 104, by causing the weld head to move, or by causing the substrate to move). Similarly, the position of the tungsten electrode 105 (e.g., the height of the tungsten electrode 105 and the lateral position of the tungsten electrode 105), the position of the distal end of the filler wire 110 (e.g., the point at which the filler wire 110 enters the weld pool) and the filler wire feed rate may be controlled. The welding control system may also include a welding power supply that may control the voltage across, or the current flowing through, the arc.

The groove 104 may not be straight, its width may vary along its length, and it may not be perfectly aligned with the axes of actuation of the travel control system, so that simply driving the travel control motor without making vertical or lateral adjustments to the elements of the weld head may result, as the weld progresses, in misalignment between the groove 104 and the weld, or in variations in the thickness of the metal layer deposited during each pass, or in a weld defect. As such, a sensing system may be employed to measure various geometric parameters of the process, and the measurements may be used to control the actuators and the welding power supply.

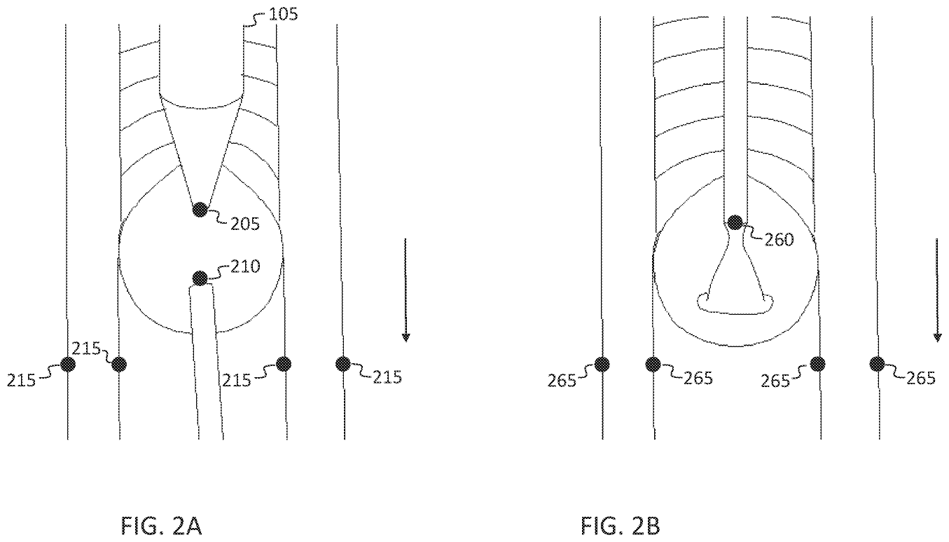

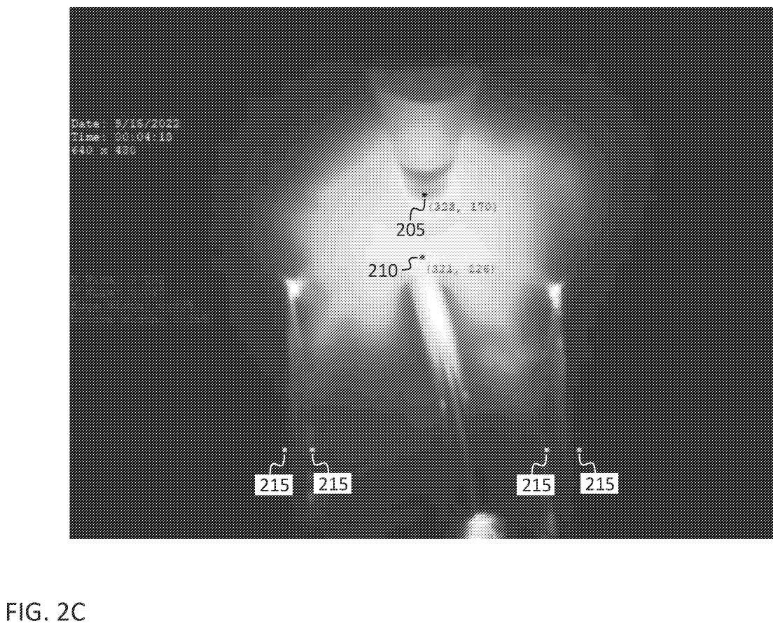

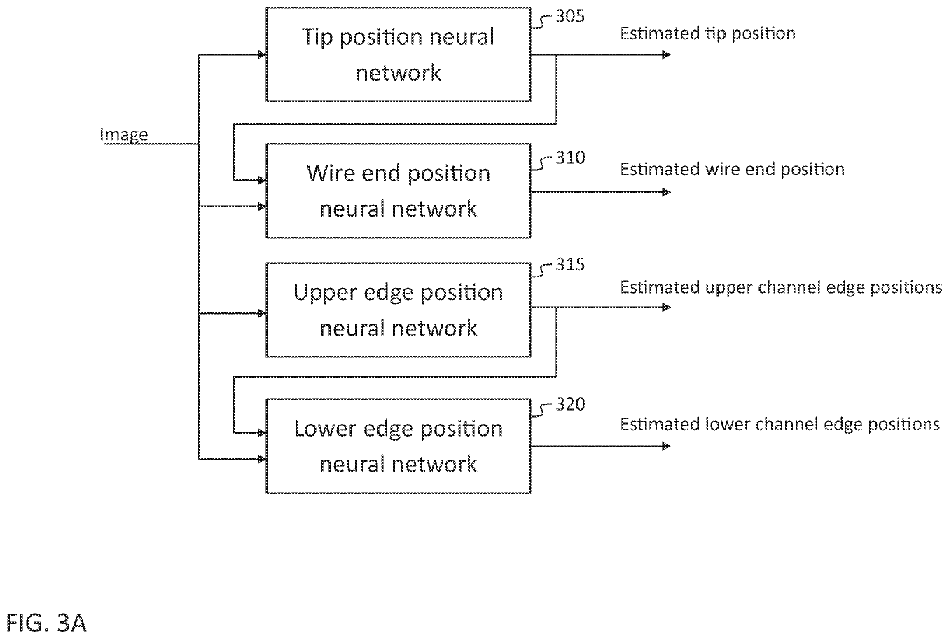

The sensing system may employ a weld monitoring camera 115, which may be a video camera configured to obtain images of the weld pool, of the tungsten electrode 105, of the filler wire 110, and of a portion of the substrate, as the weld progresses. In some embodiments, the system includes several weld monitoring cameras 115 (e.g., two weld monitoring cameras, as illustrated in FIGS. 1C and 1D). The images may be analyzed by a machine learning system (e.g., a system including one or more neural networks, as discussed in further detail below). FIGS. 2A and 2B show examples of such an image (for GTAW and GMAW respectively), labeled with points of interest in the image that the machine learning system may identify. FIG. 2C is a single frame of a video obtained by a weld monitoring camera 115 in a GTAW system, with points of interest 205, 210, 215 superimposed on the image.

The sensing system may (e.g., using the machine learning system) estimate (i) (in a GTAW system) the position (e.g., the height and lateral position) of the tip on the tungsten electrode 105 (labeled 205 in FIG. 2A), (ii) the position (e.g., the height and lateral position) of the distal end of the filler wire 110 (labeled with a point 210 in FIG. 2A and 260 in FIG. 2B), and (iii) the lateral position of each of four points of intersection between four edges of the groove 104 and a reference plane (labeled 215 in FIG. 2A and 265 in FIG. 2B). The four edges of the groove 104 may be the two upper edges, at which the walls of the groove 104 intersect the upper surface of the substrate, and the two lower edges, at which the walls of the groove 104 intersect the lower surface of the groove 104 (which may be the lower surface formed when the groove 104 is machined, or the upper surface of a preceding pass of the weld, e.g., a previously deposited weld layer 106). The reference plane may be a plane defined by a horizontal line in the image, so that all four points of intersection may fall on a horizontal line in the image.

From the estimated parameters, (i) (in a GTAW system) the error in the position of the tungsten electrode 105 relative to its target position, (ii) the error in the position of the distal end of the filler wire 110 relative to its target position, and (iii) the depth of the groove 104 and (iv) the width of the bottom of the groove 104 may be calculated. The target position of the tip of the tungsten electrode 105 for GTAW, and of the distal end of the filler wire 110 for GMAW, may be a certain height above the center of the groove 104, or it may move from left to right as the weld progresses, e.g., if a weave bead is used. In some embodiments, the height of the distal end of the filler wire 110 in a GMAW system may be estimated based on the arc voltage instead of, or in addition to, being estimated based on images from a weld monitoring camera 115. For GTAW applications, the target position of the distal end of the filler wire 110 may be offset vertically by a fixed amount from the tip of the tungsten electrode 105 and horizontally aligned with the tip of the tungsten electrode 105. The depth of the groove 104 and the width of the bottom of the groove 104 may be calculated from (i) the separation between the points of intersection corresponding to the two upper edges of the groove 104, (ii) the separation between the points of intersection corresponding to the two lower edges of the groove 104, and from knowledge of the slope of the walls of the groove 104.

Commands may be sent to the welding control system to minimize the error in the position of the tungsten electrode 105 and the error in the position of the distal end of the filler wire 110, or to keep these errors sufficiently small that the quality of the weld will be acceptable. The estimated depth of the groove 104 may be used to select the thickness of the metal layer to be deposited during the present pass, so that the remaining depth of the groove 104, after the present pass is completed, will be equal to (or nearly equal to) a target depth. For example, the target thickness of the of the metal layer to be deposited during the present pass may be calculated by dividing the estimated depth of the groove 104 by the number of passes remaining, including the present pass, if a flush weld (e.g., a weld with a bead having no crown) is to be produced.

The estimated width of the groove 104 may be used to calculate the rate of metal deposition per unit length of the weld that corresponds to the target thickness of the metal layer to be deposited during the present pass. The wire feed rate and travel speed may then be adjusted to achieve this rate of deposition (as discussed in further detail below), and the heating power may be adjusted in accordance with the wire feed rate and the travel speed, by adjusting the voltage or the current (or both) of the welding power supply. Where a weave (oscillating) motion pattern is used, the width may also be used to calculate the oscillation stroke, speed and dwell times. Where a split bead weld formation is used (more than one bead per layer), the width may also be used to calculate the position of each weld bead relative to other weld beads or to the sides of the weld groove 104.

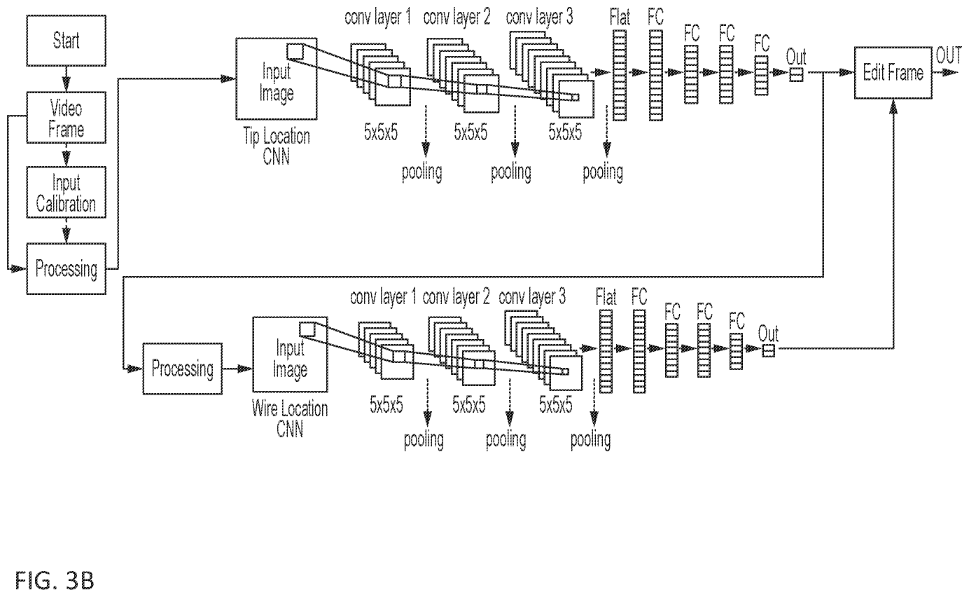

Referring to FIG. 3A, several interconnected neural networks may be employed to estimate the position of the tungsten electrode 105, the position of the distal end of the filler wire 110, the positions of the points of intersection corresponding to the upper edges of the groove 104 and the positions of the points of intersection corresponding to the lower edges of the groove 104. A first neural network 305 receives an image from the weld monitoring camera and estimates the coordinates of the point defining the position of the tip of the tungsten electrode 105. The estimated position of the tip of the tungsten electrode 105 is employed by the welding control system as discussed above, and the estimated position of the tip of the tungsten electrode 105 is also fed to a second neural network 310, which may use both the estimated position of the tip of the tungsten electrode 105 and the image to estimate the position of the distal end of the filler wire 110. A third neural network 315 may receive the image and estimate the positions of the upper edges of the groove 104 (e.g., it may estimate the horizontal coordinates of the points of intersection corresponding to the upper edges of the groove 104), and a fourth neural network 320 may receive (i) the estimated horizontal coordinates of the points of intersection corresponding to the upper edges of the groove 104 and (ii) the image, and it may estimate the positions of the lower edges of the groove 104 (e.g., it may estimate the horizontal coordinates of the points of intersection corresponding to the lower edges of the groove 104). FIG. 3B shows the internal structure of the first neural network 305 and the second neural network 310, in some embodiments. The neural network may be implemented in a processing circuit (discussed in further detail below) or in an analog circuit or in a hybrid analog and digital circuit.

Each neural network may be trained using supervised training. For this training, a set of labeled images may be generated by labelling images obtained from weld monitoring cameras while welds are in progress, with the coordinates of the points of interest. The labelling may be performed manually, by an experienced operator. The size of the training data set may be increased by adding to it modified versions of labeled images. For example, a previously labeled image may be translated horizontally by a certain amount, and the horizontal coordinates of the labels may be adjusted accordingly, to create an additional labeled image. The result of the training may be a set of filters, weights, and biases (or a neural network model) that, when loaded into the neural networks, cause the neural networks to estimate the coordinates of the points of interest in an image of a weld in progress. A collection of weights, filters, and biases may be referred to as a “model”.

An analogous approach may be used to train a neural network to recognize (and find the coordinates of) points of interest in an image, from a weld monitoring camera, of a welding setup before welding starts. Such an image may differ from an image of a weld in progress in that the illumination may be different (being provided by a suitable light source instead of being provided primarily by the arc) and in that the weld pool (and the point of entry of the distal end of the filler wire 110 into the weld pool) may be absent. In some embodiments the neural networks of FIGS. 3A and 3B are trained twice, once with images of welds in progress and once with images of a welding setup before welding starts, to produce, respectively, a first model and a second model. The second model may then be used (i.e., loaded into the neural networks) to align the tungsten electrode 105 and the filler wire 110 with the groove 104 before the weld starts. Once this alignment is completed, the first model may be loaded into the neural network, an arc may be started, and the weld may proceed using the first set of weights.

In a neural-network-controlled welding system, or in a welding system without such control, the travel speed may be calculated based on the filler wire diameter, the cross-sectional area of the weld layer 106, and the filler wire feed speed using equations derived as follows.

To the extent that the volume of the filler metal is preserved, the rate at which filler metal volume is added to the weld pool through the filler wire 110 is equal to the rate at which filler metal is carried away from the weld pool in the form of the completed weld layer 120. The rate at which filler metal volume is added may be calculated as the product of the cross-sectional area A_{f} of the metal of the filler wire 110 and the filler wire feed rate v_{f}:

$${A}_{f} {v}_{f}$$

where, for round wire (i.e., feed wire having a solid circular cross section), the cross-sectional area A_{f} is given by:

$${A}_{f} = \frac{π {ϕ}^{2}}{4} ,$$

where φ is the diameter of the filler wire 110. The rate at which metal is carried away from the weld is:

$${A}_{L} {v}_{t}$$

where A_{L} is the cross-sectional area of the weld layer and vₜ is the travel speed. For a weld layer with a rectangular weld groove, the cross-sectional area may be written

$${A}_{L} = WT$$

where W is the width of the groove (and of the layer) and T is the thickness or “height” of the layer.

Setting the rate at which metal is added equal to the rate at metal is carried away results in the following:

$${v}_{t} = \frac{π {ϕ}^{2} {v}_{f}}{4 WT} . \qquad ( 1 )$$

As such, given a weld width, a layer height, a filler rod cross-sectional area, and a filler wire feed rate, it may be possible, from Equation (1), to determine the travel speed that will result in the desired layer height (with lower travel speeds resulting in a greater layer height, and greater travel speeds resulting in a smaller layer height).

If the filler wire 110 is hollow (e.g., hollow, flux-cored wire) instead of being solid wire, then the cross-sectional area of the metal of the filler wire 110 may be, e.g., 25% of the total cross sectional area of the filler wire 110 (with the remaining 75% of the cross-sectional area being flux), i.e.,

$${A}_{f} = m \frac{π {ϕ}^{2}}{4} ,$$

where m is a correction factor (or “efficiency factor”) that accounts for the fact that only a fraction of the filler wire 110 is metal, and Equation (1) may be modified to:

$${v}_{t} = m \frac{π {ϕ}^{2} {v}_{f}}{4 WT} , \qquad ( 2 )$$

(where, e.g., for filler wire 110 that is 75% flux and 25% metal by volume, m=0.25).

Equation (1) may not hold perfectly if the volume of the filler metal is not preserved (e.g., to the extent that some filler metal is lost, e.g., to spatter or oxidation, or as a result of other mechanisms (e.g., changes in crystalline structure that affect the density)). Equation (1) may also not hold perfectly if the weld layer height is sufficiently great for some of the filler metal to spill out of the groove 104. However, the equation may nonetheless be used with satisfactory results if it holds approximately, or a correction may be made to the equation if the extent to which the process deviates from ideal is known. For example, Equation (2) may be used and the correction factor m may also (or instead) be used to compensate for various mechanisms that prevent Equation (1) from holding perfectly. For example, if 5% of the metal of the filler wire 110 is lost to spatter, then a value m=0.95 may be used (or, if m is different from 1 for other reasons, then the value of m may be decreased by 5% to account for the loss to spatter).

If the ends of the pipes are shaped so that the groove is V-shaped, then for each pass around the pipe the weave may be increased so that the width of the weld is substantially equal to the width of the bottom of the partially-filled V. Equation (1) may then be used, with W being the width of the bottom of the partially-filled V (or, for greater accuracy, with W being the width of the V at a height one-half layer thickness above the bottom of the partially-filled V). In some embodiments, the substrate is any substrate (e.g., plates to be joined, or a substrate on which an overlay layer of metal is to be formed) and the travel rate may be calculated using Equation (1) or Equation (2) based on the filler wire diameter and filler wire feed speed, and on the height and width of the weld layer 120 to be formed (or, more generally, using

$${v}_{t} = \frac{{A}_{f} {v}_{f}}{{A}_{L}}$$

if the filler wire 110 is not round and solid, or if the cross section of the weld layer 120 is not rectangular).

In operation, the welding system may calculate the target travel speed to be used and automatically set the travel actuator (which may cause the pipes to rotate, or the weld head to travel around the outside of the pipes at the joint) to produce travel at the target travel speed. The system may obtain the input variables in Equation (1) from various sources, including from operator input (e.g., supplied to the welding system through an input device such as keyboard) or from sensors. For example, the operator may adjust the wire feed speed by instructing the welding system to increase or decrease filler wire feed speed until the weld pool has the desired characteristics. The welding system may therefore be aware of the filler wire feed speed from the operator's most recent instruction. The width of the weld may be measured by the welding system using the machine learning based image analysis disclosed herein, or by other methods.

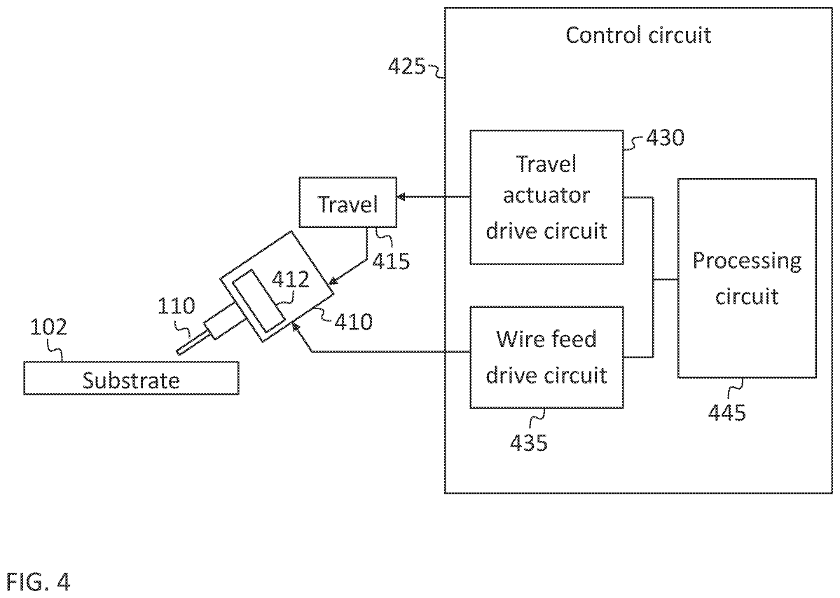

FIG. 4 shows a welding system that may implement travel rate control based on the equations above. In some embodiments, such a welding system includes a welding head 410 which includes a filler wire feed unit 412 for supplying the filler wire 110 to the weld pool 205. The system for heating the weld pool is not explicitly shown; it may be, for example, an arc (with current flowing through the filler wire 110, or through a separate (e.g., tungsten) electrode), or a laser. The system may further include a travel actuator 415 for controlling the relative motion of the welding head 410 and the substrate 110. The welding system may also include a control circuit 425, including (i) a travel actuator drive circuit 430, for interfacing to the travel actuator 415, (ii) a wire feed drive circuit 435, for controlling the feed speed of the filler wire 110, and (iii) a processing circuit 445 (described in further detail below) for performing high-level control functions such as commanding the travel actuator 415. The system may also include other elements (not shown) such as a welding power supply and controller, and one or more user interface devices such as a display, a keyboard, or a mouse.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, the word “or” is inclusive, so that, for example, “A or B” means any one of (i) A, (ii) B, and (iii) A and B.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although exemplary embodiments of systems and methods for control of welding systems have been specifically described and illustrated herein, many modifications and variations will be apparent to those skilled in the art. Accordingly, it is to be understood that systems and methods for control of welding systems constructed according to principles of this disclosure may be embodied other than as specifically described herein. The invention is also defined in the following claims, and equivalents thereof.

1. A system for welding, comprising:
a weld head;
a first weld monitoring camera; and
a machine learning system,
wherein the machine learning system is configured, while the weld head forms a weld layer in a groove, to estimate the position of a distal end of a filler wire relative to the groove.

2. The system of claim 1, wherein the estimating comprises estimating, based on an image obtained by the first weld monitoring camera, the position of a first point of interest, the first point of interest being a point of intersection of a first edge of the groove with a reference plane.

3. The system of claim 2, wherein the estimating comprises estimating the position of four points of interest including the first point of interest, each of the four points of interest being a point of intersection of an edge of the groove with the reference plane.

4. The system of claim 3, wherein the estimating of the position of the first point of interest comprises estimating, in the image, an intersection of a line corresponding to the first edge and a line corresponding to the reference plane.

5. The system of claim 4, wherein the machine learning system is further configured to estimate the depth of the groove.

6. The system of claim 4, wherein the machine learning system is further configured to estimate the width of the bottom of the groove.

7. The system of claim 4, wherein the estimating further comprises estimating the position of a fifth point of interest, the fifth point of interest corresponding to the distal end of a filler wire.

8. The system of claim 4, wherein the machine learning system is further configured to estimate an error in the position of the distal end of the filler wire relative to a target position of the distal end of the filler wire.

9. The system of claim 4, wherein the estimating further comprises estimating the position of a sixth point of interest, the sixth point of interest corresponding to the tip of a tungsten electrode of the weld head.

10. The system of claim 9, wherein the machine learning system is further configured to estimate an error in the position of the tip of the tungsten electrode relative to a target position of the tip of the tungsten electrode.

11. The system of claim 1, wherein the machine learning system comprises a first neural network for estimating, in an image obtained by the first weld monitoring camera, a position of a tungsten electrode.

12. The system of claim 1, wherein the machine learning system further comprises a second neural network for estimating a position of the distal end of a filler wire.

13. The system of claim 1, wherein the estimating of the position of the distal end of the filler wire comprises estimating the position of the distal end of the filler wire based on:
an estimated position of the tungsten electrode; and
the image.

14. The system of claim 1, wherein the machine learning system further comprises a third neural network for estimating a position of an upper edge of the groove.

15. The system of claim 1, wherein the machine learning system comprises a fourth neural network for estimating a position of a lower edge of the groove.

16. The system of claim 15, wherein the estimating of the position of the lower edge of the groove comprises estimating the position of the lower edge of the groove based on:
an estimated position of the upper edge of the groove; and
the image.

17. A method, comprising:
calculating a travel speed of a substrate relative to a weld head, based on:
a feed speed of a filler wire;
a dimension of the filler wire; and
a dimension of a weld layer to be formed.

18. The method of claim 17, wherein the dimension of the filler wire is the diameter of the filler wire.

19. The method of claim 17, wherein:
the dimension of the weld layer is the thickness of the weld layer, and
the calculating is further based on the width of the weld layer.

20. The method of, wherein the calculating is further based on an efficiency factor.
